(19) United States
(12) Patent Application Publication
(10) Pub. No.: US 2007/0182167 A1
(43) Pub. Date: Aug. 9, 2007

(54) Door handle with built-in string latch actuation mechanism for door opening

(76) Inventor: Fernando Garofoli, Castelfidardo (AN) (IT)

Correspondence Address: Armstrong Westerman and Hattori, 502 Washington Avenue, Suite 220, Towson, MD, 21204, US

(21) Appl. No.: 10/588,536

(22) PCT Filed: Oct. 5, 2004
(86) PCT No.: PCT/IT04/00552

§ 371 Date: Aug. 7, 2006

(30) Foreign Application Priority Data
Feb. 10, 2004 (IT) 2004 A 000021

(51) Int. Cl. E05B 3/00

(52) U.S. Cl. 292/336.3

(57) ABSTRACT

The present invention refers to a door handle with built-in in spring latch actuation mechanism for door opening, whose actuation can be inhibited from the external side of the door with a key inserted into the body of the handle, while from the internal side of the door the actuation can be inhibed by means of blocking rod that slides inside the blody of the handle.

The present patent application refers to a door handle with built-in spring latch actuation mechanism for door opening.

As it is known, door handles are used in combination with a lock that includes a spring latch designed to engage in a corresponding housing located on the frame, it being evident that the handle is used to actuate the mechanisms designed to retract the spring latch.

The mechanisms and the latch are usually enclosed in a box with a square hole in which the through pin is inserted; the two handles are assembled at the ends of the through pin on the two opposite sides of the door, that is on the internal and external side.

The box usually contains a bolt that can be actuated with a key.

The box is engaged into a suitable housing located along the door leaf and interfaced with the housing located on the frame, where the spring latch tends to insert spontaneously under the expulsive thrust of the return spring.

This kind of handles can only be used in wooden or metal doors, since the box must be enclosed and hidden inside a deep housing.

Special handles must be used for glass doors, where the latch is housed into a box with reduced size and refined design, since the box remains completely visible.

The purpose of the present invention is to realise a door handle with built-in spring latch in order to eliminate the bulky box that contains the mechanism and the bolt with key.

This need is particularly felt for glass doors with perimeter frame having a reduced width, where space is not enough to contain and hide the box.

The fact that the actuation mechanisms of the spring latch and the lock are incorporated into the handle permits to assemble the handle on glass doors, since the framework must only house the spring latch and the housing and guiding box with reduced size, which is perfectly compatible with the framework size.

It appears evident that, although it has been specifically designed for glass door with framework, the door handle of the invention can be used also for standard wooden doors.

The peculiarity of the handle of the invention also consists in the fact that the handle houses the mechanisms used to close and lock the latch that can be actuated manually by means of a button from the internal side or by means of a safety key from the external side.

Another characteristic is that the keyhole is located on the ending section of the handle and the shape of the body of the key is an extension of the body of the handle, thus hiding the key.

The finished product will be an innovation in the sector due to the fact it does not impair the clean shape of glass doors and perfectly integrates with the door framework.

The body of the handle is composed of two parts, a lower part and an upper part that are assembled and provided with finishing moulding to cover the central junction line.

An opening lever is placed between the two parts and pivoted on a vertical pin, ending with a hook that engages into a through hole located on the spring latch, while the other end of the lever features an enlarged head that acts as opening button.

The opening button projects from the back of the handle and receives the expulsive thrust of a spring.

If the button is pressed, the spring is compressed and the lever rotates with respect to the pivoting pin, thus determining the retraction of the spring latch with the hook.

The handle of the invention is realised in two different embodiments, of which one is designed for assembly on the internal side of the door and is characterised by a cursor closing mechanism, and the other embodiment is designed for assembly on the external side of the door and characterised by a cylinder closing mechanism with key.

The internal handle side features a blocking rod that slides inside a housing and guiding track and ends with a point designed to prevent the latch from travelling backwards when the blocking rod is pushed at the end of the forward travel, thus overcoming the resistance of the expulsion spring.

The rod is stopped at the end of the forward travel due to a hooking pin that projects from the rod and engages into a suitable notch located on the opening lever partially above the blocking rod.

As soon as the opening lever is actuated, the notch is moved away from the hooking pin, thus releasing the blocking rod that snaps out of the handle body under the thrust of the expulsion spring.

Also the external handle is provided with the opening lever with ending hook, but not with blocking rod, being provided with a closing device of cylindrical block type with key, as mentioned above.

A square bracket is applied on the shaft of the cylindrical block and is rotated by 90° when the key is turned, thus passing from an inert position to an active position, where the actuation of the opening rod is interfered by the square bracket.

This means that if the door is closed from the external side with the key, it will always be possible to open the door from the internal side, since external closing holds the opening lever, but leaves the spring latch free to move backwards, with no obstacle for the actuation of the opening lever of the internal handle.

For major clarity, the description of the invention continues with reference to the enclosed drawings, which are intended for purposes of illustration only and not in a limiting sense, whereby:

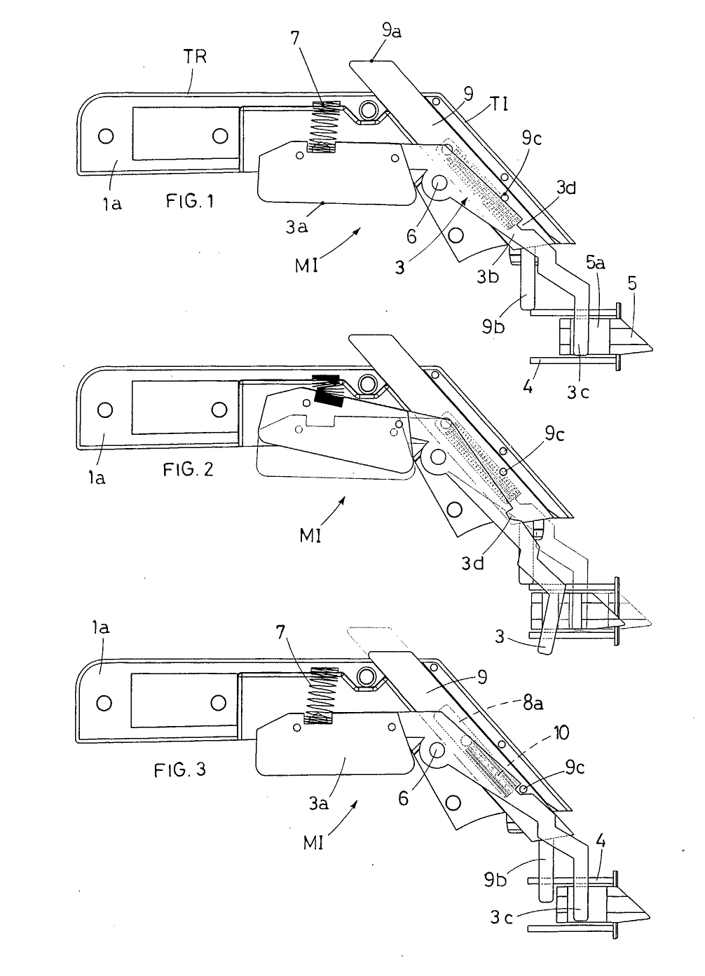

FIG. 1 is a top view of the internal handle in idle position with the upper part removed to show the position and layout of internal components in the lower part;

FIG. 2 is the same as FIG. 1, except for the fact that it refers to the opening position;

FIG. 3 is the same as FIG. 1, except for the fact that it refers to the blocking position;

FIG. 4 is a top view of the external handle in idle position with the upper part removed to show the position and layout of internal components in the lower part;

FIG. 5 is the same as FIG. 4, except for the fact that it refers to the opening position;

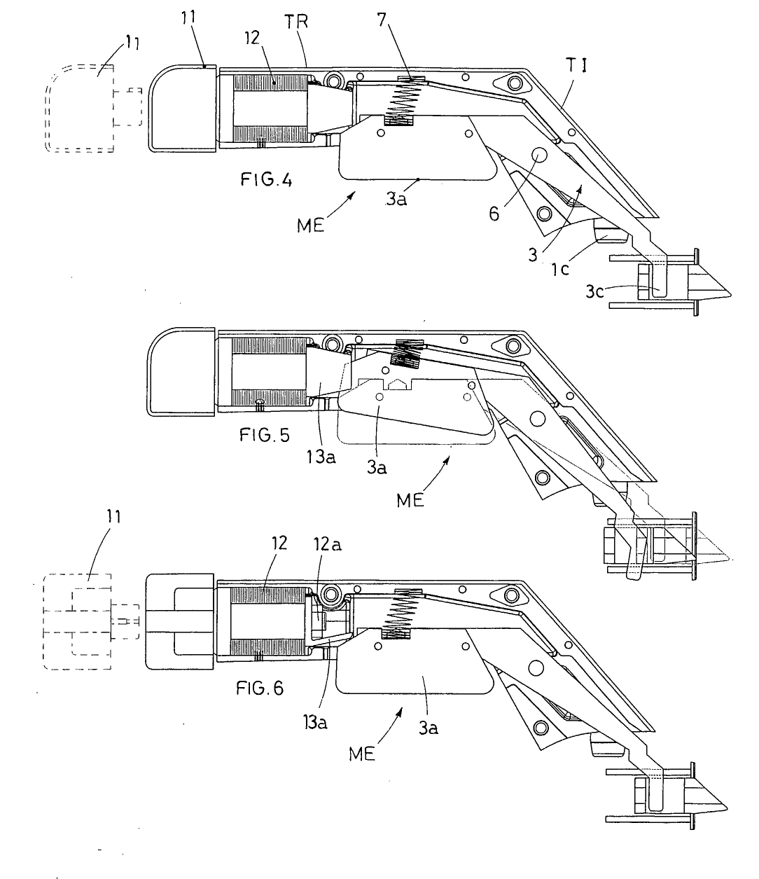

FIG. 6 is the same as FIG. 1, except for the fact that it refers to the blocking position;

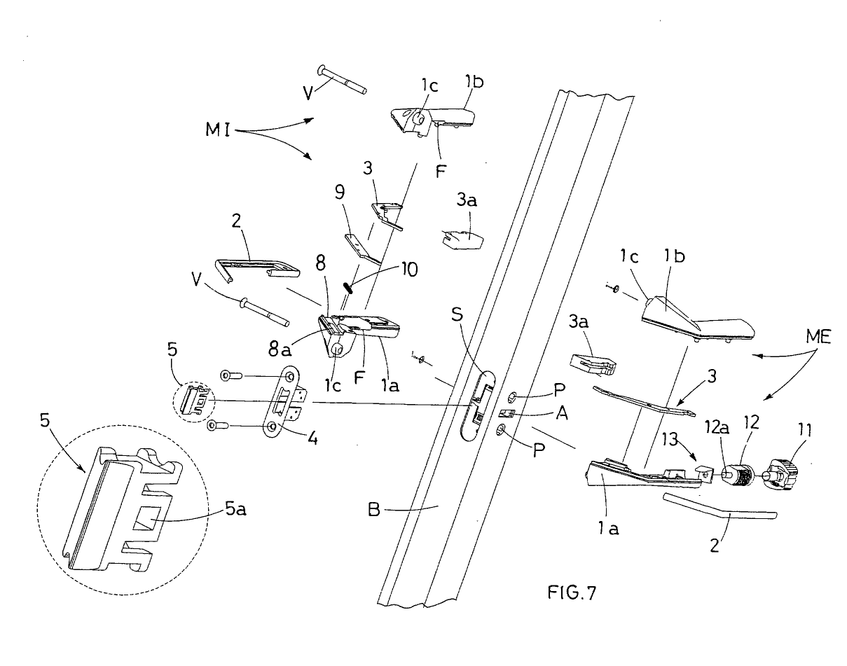

FIG. 7 is an exploded view of external and internal handles mounted on the section used for the door leaf.

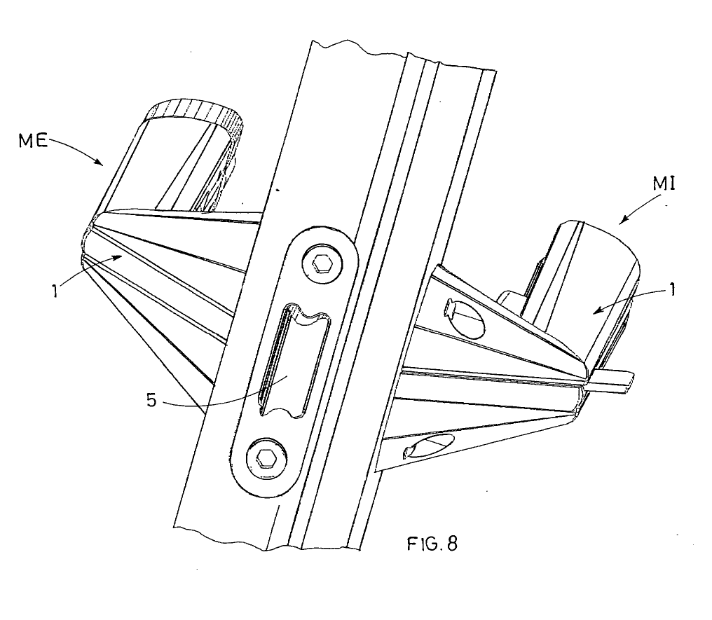

FIG. 8 is a perspective view of the door leaf with spring latch in the foreground and the two handles fixed on the opposite sides of the door.

FIG. 9 is basically the same as FIG. 4, except for the type of lock used on the external handle, which is of sliding bolt type;

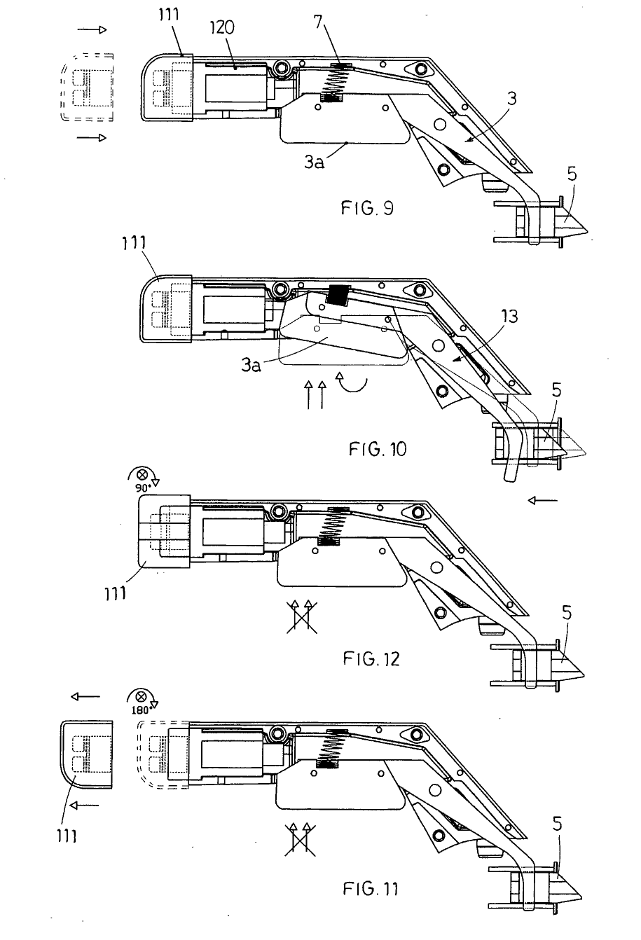

FIGS. 10, 11 and 12 are the same as FIG. 9, except for the fact that they show the sliding latch of the lock in three different positions.

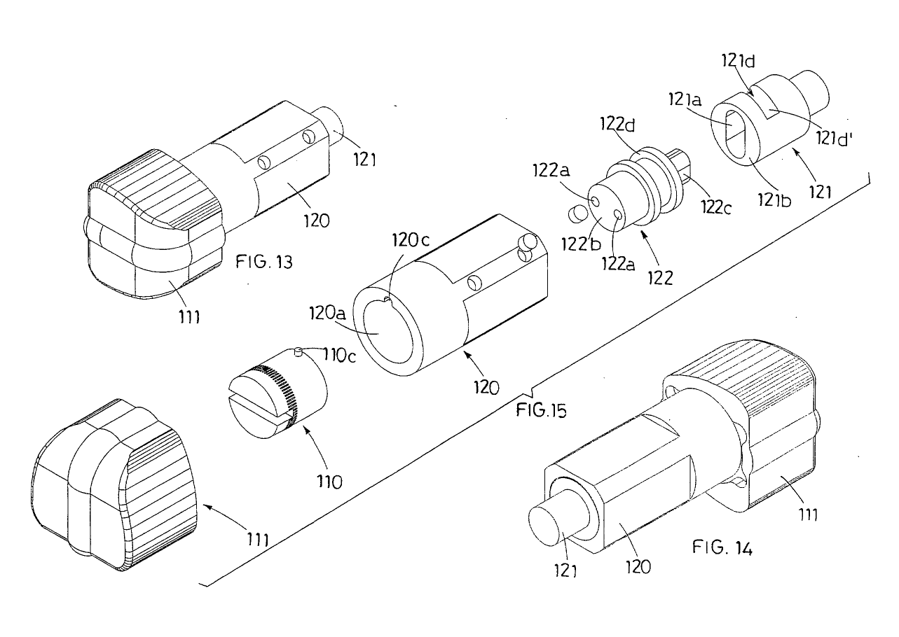

FIGS. 13 and 14 are an axonometric view of the lock with sliding latch seen from different angles and with the key inserted.

FIG. 15 is an exploded axonometric view of the lock with sliding latch.

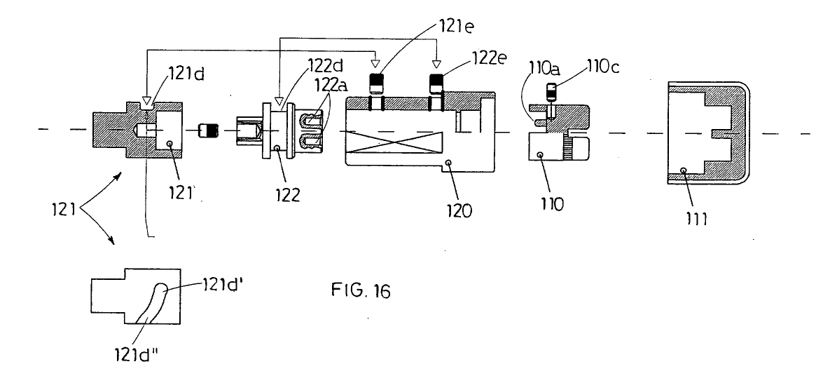

FIG. 16 is an exploded cross-section of the lock with sliding bolt.

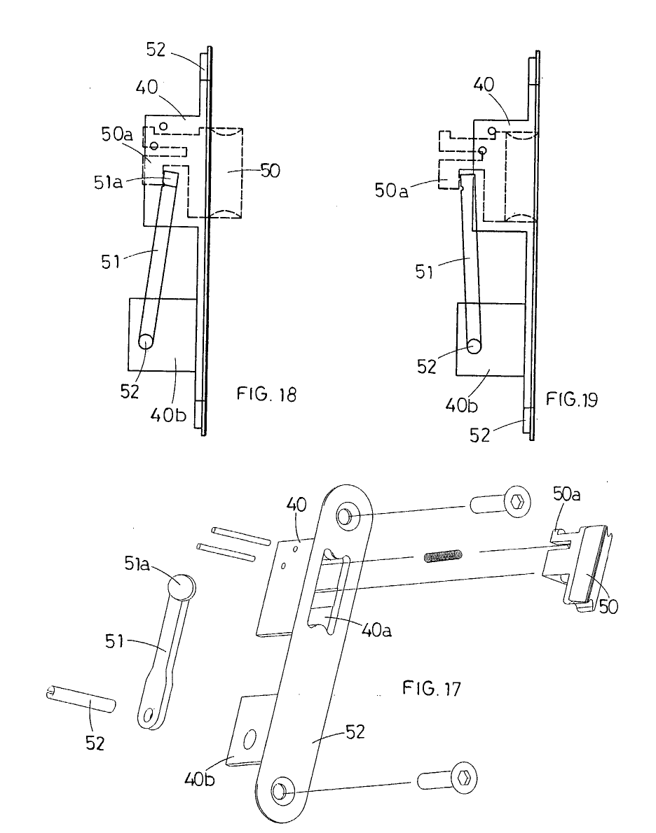

FIG. 17 is an axonometric view of the housing and guiding box of a special spring latch.

FIGS. 18 and 19 are a side view of the box of FIG. 17 with the spring latch in expelled and retracted position, respectively.

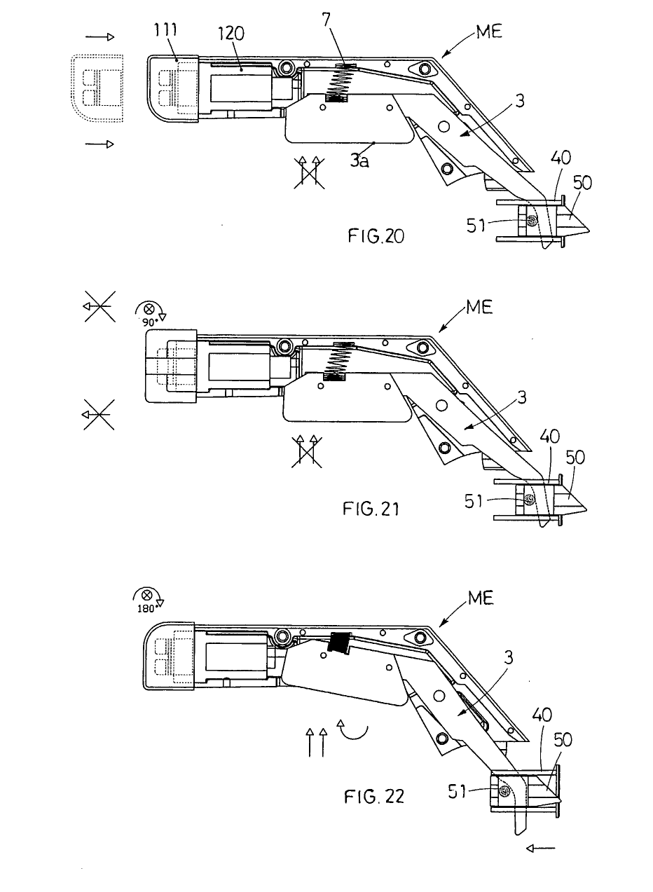

FIGS. 20, 21 and 22 are basically the same as FIG. 10 to 12, with the only difference that they refer to a handle provided with the spring latch illustrated in FIGS. 17, 18 and 19.

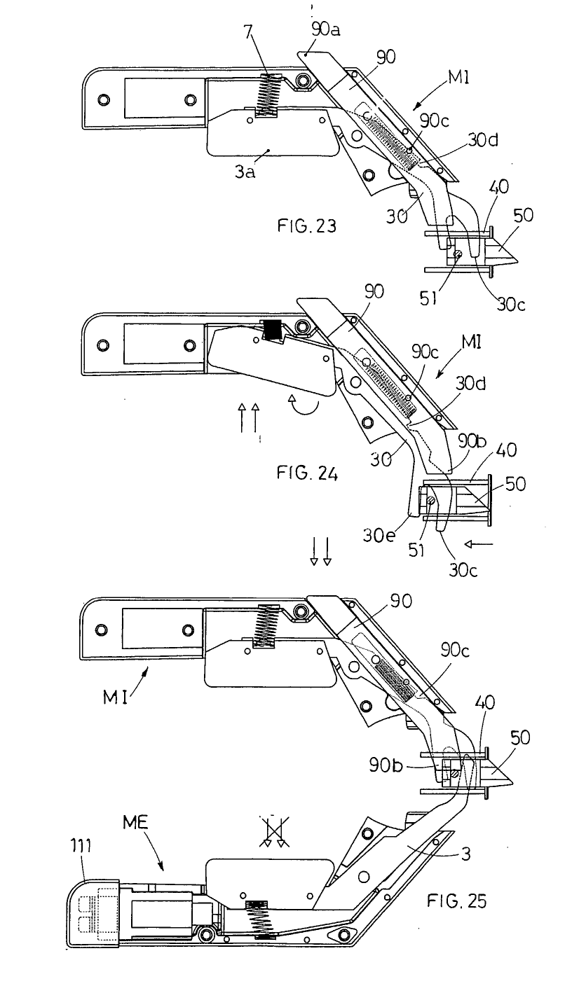

FIGS. 23, 24 and 25 show an embodiment of the handle of the invention provided with an opening lever and blocking rod that slightly differ from the ones used in the embodiments shown in the preceding figures.

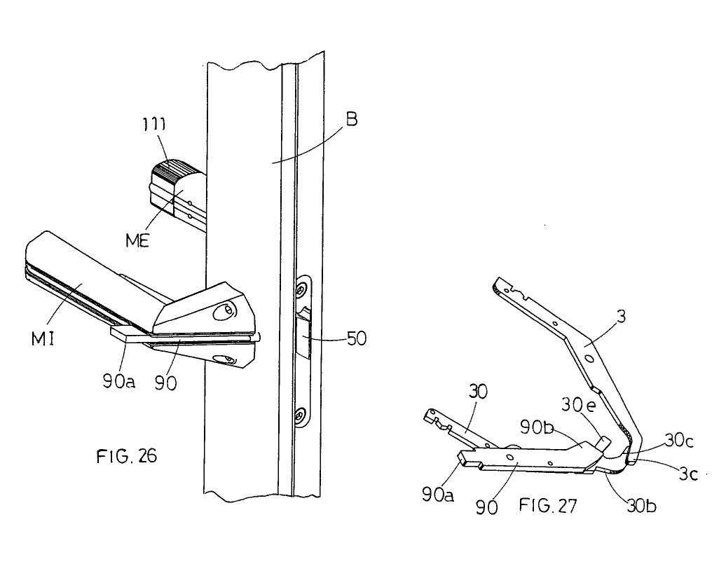

FIG. 26 is an axonometric view of the handle of the invention in the embodiment shown in FIGS. 23 to 25, with blocking rod not inserted.

FIG. 27 shows the mutual position of the opening lever and blocking rod contained in the handle of FIG. 26.

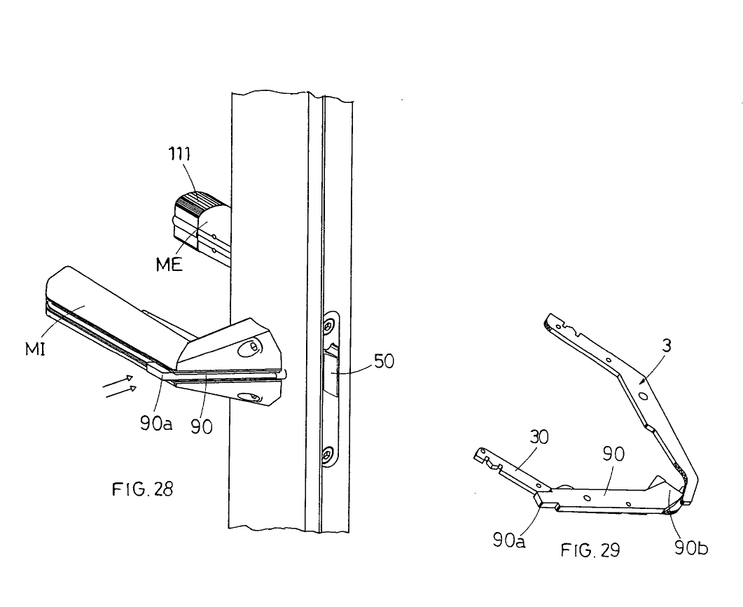

FIG. 28 is an axonometric view of the handle of the invention in the embodiment shown in FIGS. 23 to 25, with blocking rod inserted.

FIG. 29 shows the mutual position of the opening lever and blocking rod contained in the handle of FIG. 28.

With reference to FIGS. 1 to 3, the handle of the invention in its internal version (MI) comprises a body-handle (1) obtained by matching a lower part (1a) with an upper part (1b), with the junction line preferably hidden by a finishing moulding (2).

It must be noted that the moulding (2) is interrupted in the internal section of the handle provided with a thin slot (F) from which the opening button (3a) of the opening lever (3) projects.

Moreover, it must be noted that the body-handle (1) has an L-shaped profile with a first rectilinear section (TR) parallel to the door that basically acts as handle, joined to a second inclined section (TI) that is inserted into the door by means of an opposite pair of pins (1c), one for each part (1a, 1b).

In view of the above, the leaf (B) of the door must be provided with an overlapped pair of through holes (P) to insert the pins (1c).

The body-handle (1) is fixed to the leaf (B) of the door in central position with respect to the housing (S) where the housing and guiding box (4) of the spring latch (5) is inserted.

The body-handle (1) contains an opening lever (3) pivoted on a pin with vertical axis (6) and made of a shaped plate whose profile matches the profile of the body-handle (1), meaning that the lever (3) has a first support section for the opening button (3a) housed in the handle and joined with a second shaped section (3b) that ends with a hook (3c) that projects from the front end of the inclined section (TI) of the body-handle (1).

The hook (3c) is designed to be inserted through a suitable slot (A) located on the leaf (B) of the door, penetrating the housing and guiding box (4) of the spring latch (5), whose body is provided with a through hole (5a) into which the ending section of the hook (3c) is inserted.

A spring (7) acts on the back of the opening button (3a) and pushes it constantly outside the body-handle (1), thus holding it in the ejection and idle position, as shown in FIG. 1.

The lower part (1a) houses a track (8) in the inclined section (TI), which exactly houses a sliding blocking rod (9); in idle state the blocking rod (9) projects shortly from the front of the body-handle (1) and more exactly on the connection angle between the rectilinear section (TR) and the inclined section (TI).

In other words, it can be said that the projecting end of the rod is the blocking button (9a) of the handle.

The other end of the blocking rod (9) ends with a point (9b) designed to go through the slot (A) on the leaf (B); when the blocking rod (9) is actuated, the point (9b) is placed on the back of the body of the spring latch (5) to oppose the return travel inside the housing and guiding box (4), as shown in FIG. 3, it being evident that door opening is subjected to the retraction of the spring latch (5).

This means that the user can prevent door opening with the blocking rod from the internal side of the door.

On the bottom of the sliding track (8) a cavity (8a) houses a return spring (10) hooked to the blocking rod (9) designed to push the blocking rod (9) and eject the button (9a) from the body-handle (1).

Above the blocking rod (9), a hooking pin (9c) with vertical axis engages into a notch (3c) suitably provided along the external profile of the opening lever (3) at the end of actuation travel of the rod (9).

It must be noted that the opening lever (3) is placed partially above the blocking rod (9) with the shaped section (3b), so that the blocking rod (9) can slide forward with interference and friction of the hooking pin (9c) against the external profile of the shaped section (3b).

This means that the forward movement of the blocking rod (9) causes the automatic backward movement of the opening lever (3) that moves forward, under the action of the spring (7), as soon as the hooking pin (9c) reaches the engaging notch (3d).

The deactivation of the blocking rod (9) does not require special manoeuvres, since it is performed automatically following the actuation of the opening lever (3) that rotates and releases the hooking pin (9c) from the engaging notch (3d), thus snapping out of the blocking rod (9) due to the expulsion thrust of the spring (10), as shown in FIG. 2.

The automatic deactivation of the blocking rod (9) allows for define the handle of the invention as an “anti-panic” handle.

With reference to FIGS. 4 to 6, the external handle of the invention differs from the internal handle only in that it is not provided with the blocking rod (9) and features a key locking device (11, 12, 13) that, once inserted, prevents the opening lever (3) from being moved.

This means that the user can lock the door with the key (11) from the external side of the door and take the key with him/her.

In any case, also if the door is locked with the key from the outside, the door can be opened from the inside by acting on the opening lever, in view of the fact that the key-locking device acts on the opening lever (3) of the handle only, and not on the spring latch (5) of the door,

Conversely, if the door is closed from the inside, the actuation of the opening lever (3) on the external handle does not allow to open the door, since the spring latch (5) of the door cannot move backwards due to the insertion of the blocking rod (9).

The end of the rectilinear section (TI) of the handle features a lock with cylindrical block (12) housing with a shaft (12a) that projects from the block (12) and is fixed to an L-shaped bracket (13).

The key (11) of the lock can be used to drag into 90° rotation the shaft (12a) so that the horizontal wing (13a) of the L-shaped bracket (13) is consequently moved from an horizontal to a vertical plane.

The horizontal wing (13a) of the L-shaped bracket (13) is dimensioned in such a way that when it is positioned on a vertical plane—as shown in FIG. 6—the opening lever (3) cannot be actuated, as the insertion of the button (3a) inside the body-handle (1) is opposed by the wing (13) that, conversely, loses its capability of obstructing the travel of the opening button (3a) when the same is in horizontal parallel position with respect to the button (3a), as shown in FIG. 5.

Finally, it must be noted that the external handle (ME) is fixed to the internal handle (MI) by means of screws (V) that go through the fixing pins (1c) of the parts (1a, 1b) of the internal handle (MI) and are tightened into the threaded pins (1c) of the parts of the external handle (ME) after passing through the holes (P).

With reference to FIGS. 13 to 16, the description continues with reference to a second embodiment of the lock positioned at the end of the rectilinear section (TI) of the handle (ME).

The lock has a cylindrical chamber (120) that houses a sliding locking bolt (121) that, once it is expelled, is positioned on the back of the opening lever (3), thus preventing its actuation due to the interference between the bolt (121) and the button (3a) of the lever, which cannot be pushed inside the body-handle (1), as shown in FIGS. 11 and 12.

The key (110) of the lock is housed inside a shaped piece (111) that protects and hides the real key (110), it being evident that the piece is shaped in such a way that it matches the aesthetics of the body-handle (1).

The dimensions of the key (110) allow to insert the key (110) exactly into the back opening (120a) of the chamber (120), from which the bolt (121) projects frontally.

The key (110) and the bolt (121) are connected by means of a rotary intermediate drum (11) housed inside the chamber (120).

More exactly, the key has a front pair of pins (110a) (see FIG. 16) that can be inserted into a corresponding pair of holes (122a) located on the rear ending section (122b) of the drum (122), provided frontally with a central pin (122c) inserted into a suitable housing (121a) on the rear ending section (121b) of the bolt (121).

In particular, the pin (122c) and the housing (121a) are coupled in such a way that the pin (122c) can slide in axial direction inside the housing (121a), but cannot turn, so that each rotary movement of the drum (122) is transmitted to the bolt (121), which can move forward or backward in axial direction with respect to the drum, without losing prismatic coupling thanks to the pin (122c).

To ensure easy, rapid centring of the two pins (110a) inside the holes (122a), the key (110) is provided with a reference radial dowel (110c) that projects from the lateral surface and is inserted and slides inside a suitable groove (120c) on the internal surface of the rear opening (120a) of the chamber (120) (see FIG. 15).

More exactly, the groove (120c) has an L-shaped profile formed of a first longitudinal section for axial insertion of the key (110) into the chamber (120) and a second transversal section that extends for a semicircle and prevents the key from being released once it has started to turn inside the chamber (120) to reach the opening position of the lock.

Both the rotary drum (122) and the bolt (121) have guiding grooves (122d and 121d) along the lateral surface where corresponding radial pins (122e and 121e) applied on the chamber (120) engage.

The guiding groove (122d) of the rotary drum (122) has a circular development on an orthogonal plane to the rotation axis of the drum. The guiding groove (121d) of the bolt (121) has a circular development formed of a first section (121d′) identical and parallel to the groove (122d) and a second section (122d″) with helical development, so that when the key (110) is inserted into the chamber (120) (see FIG. 11), the first 90° rotation of the key corresponds to a similar rotation of the bolt (121) and the drum (122) (see FIG. 12), and the second 90° rotation of the key (110) corresponds to a similar 90° rotation of the drum (121) and a roto-translation of the bolt (121) (see FIG. 10), which returns inside the chamber (120) and allows for actuating the opening lever (3).

The first section (121d′) of the guiding groove (121d) allows for inserting the key (110) and placing it, after a first 90° rotation, in a position that prevents the lock from being opened (see FIG. 12) and at the same time prevents the key (110) from being removed, due to the interference between the dowel (110c) and the transversal section of the L-shaped groove (120c) of the chamber (120).

More exactly, FIG. 11 refers to the position in which the lock is closed and the key (111) can be removed from the drum (120) or conversely inserted into the drum, in case it had been removed; for this reason, in FIGS. 6 and 11, the keys (11 and 111) are shown with a broken line when they are removed from the lock and with a continuous line when they are inserted into the lock.

As shown in FIG. 12, by dragging the key (111) in a first 90° rotation, after inserting it into the drum (120), the bolt (121) remains in expelled position, thus maintaining the lock closed, with the only difference that the key (111) cannot be removed from the drum.

As shown in FIG. 9, the second 90° rotation of the key (111) causes the retraction of the bolt (121) inside the chamber (120), thus opening the lock and allowing for actuating the opening lever (3), as shown in FIG. 10.

With reference to FIGS. 17 to 19, the description continues with another embodiment of the spring latch (5) and of the housing and guiding box (4).

According to this embodiment, the housing and guiding box (40) has a housing (40a) for the spring latch (50) provided with a rear hooked appendix (50a), which engages with the head (51a) of a vertical lever (51), whose base is pivoted by means of a horizontal pin (52) inside a fork (40) on the rear side of the plate (52) that supports the box (40).

In this case the plate (52) is tightened into the leaf (B) of the door, in such a way that the ending hook (3c) of the opening lever (3) engages with the lever (51) in its central section.

This allows for reducing the travel of the opening lever (3) that is necessary to move backwards the spring latch (50) completely, since the backward travel of the hook (3c) corresponds to the backward travel of the spring latch (50); the lower the point where the hook (3c) engages with the lever (51) is, the higher the backward travel will be in percentage. With reference to FIGS. 20 to 29, the description continues with another embodiment of the opening lever (3) and blocking rod (9), which are indicated as (30 and 90), respectively. The lever (30) and the rod (90) have been designed to operate in combination with the housing and guiding box (40), where the spring latch (50) is actuated by means of the interposition of the lever (51).

Moreover, it must be noted that the special opening lever (30) must be mounted on the internal handle (MI) only. For this reason, in FIGS. 20 to 29, the opening lever mounted on the external handle (ME) is indicated as (3).

The opening lever (30) is obtained with a shaped plate and supports an opening button (3a) at one end, while the other end terminates with a forked appendix (30b) that comprises a first hook (30c) and a second hook (30e).

The first hook (30c) is designed to hook and move the lever (51) when the opening button (3a) is pushed, as shown in FIG. 24.

As shown in FIG. 27, in idle state the hook (30c) is adjacent and overlapped with respect to the hook (3c) of the opening lever (3) mounted on the external handle (ME), as the hook (3c) is designed to hook and move the lever (51) when the opening button (3a) of the external handle (ME) is pushed.

The end (90a) of the blocking rod (90) protrudes frontally from the body-handle (1) and is provided with a hooking pin (90c) housed inside a special notch (30d) of the lever (30), as shown in FIG. 25. For this reason, the blocking rod (90) spontaneously recovers the idle position as soon as the lever (30) oscillates backwards, thus releasing the pin (90c) from the engaging notch (30d).

To close the door from the inside, the user must actuate the blocking rod (90) that ends with a catch (90b) capable of interfering with the internal profile of the hook (3c) when the blocking rod (90) is pushed forward, as shown in FIGS. 25 and 29.

The second hook (30d) of the lever (30) is used to automatically release the blocking rod (90) when the latch (50) moves back inside the housing (40a) accidentally, when the user has not actuated the opening lever (30)

It must be noted that, when the rod (90) is inserted, the second hook (30d) is engaged on the back of the lever (51), thus being interfered when the lever (51) oscillates backwards due to a backward travel of the latch (50) that is not caused by the actuation of the opening lever (30).

A similar situation may occur if the blocking rod (90) is accidentally actuated with the door open, so that the closing of the door would cause the backward movement of the latch (50) due to interference with the leaf (B) of the door frame.

It must be noted that the latch (50) can move back freely, as the catch (90b) of the rod (90) does not interfere with the latch (50) directly, unlike the blocking rod (9), whose point (9b) is positioned immediately behind the latch (50), thus preventing its backward travel, until the user actuates the opening lever (3) mounted on the internal handle (MI).

1. Door handle with built-in spring latch actuation mechanism for door opening, of the type comprising a body-handle (1) with L-shaped profile, with a first rectilinear section (TR) parallel the door that basically acts as handle, joined to a second inclined section (TI) that is inserted into the door; said body-handle (1) housing an opening lever (3, 30) pivoted on a pin with vertical axis (6), which supports an opening button (3a) with ejection spring (7), and ends with a hook (3c, 30c) that projects from the front end of the inclined section (TI) of the body-handle and can be inserted through a suitable slot (A) located on the leaf (B) of the door, reaching the housing and guiding box (4, 40) of the spring latch (5, 50) actuated by the hook (3c, 30c); handle characterised in that the body-handle (1) is composed of a lower part (1a) and an upper part (1b) that are matched together and are provided at the end of the inclined section (TI) with corresponding pins (1c) that engage into holes (P) of the door leaf, into which the screws (V) that fix the external handle (ME) to the internal handle (MI) are inserted and tightened.

2. Door handle as defined in claim 1, characterised in that it comprises a finishing molding (2) used to cover the central junction line between the parts (1a, 1b), which is interrupted in the internal section of the handle provided with a thin slot (F) from which the opening button (3a) of the opening lever (3, 30) projects.

3. Door handle as defined in claim 1, characterised in that the lower part (1a) houses a rectilinear track (8) in the inclined section (TI), which exactly houses a sliding blocking rod (9, 90), with one end (9a, 90a) that projects on the body-handle (1), and one end that terminates with a point (9b) or catch (90b) capable of passing through the slot (A) and being positioned, in case of actuation of the blocking rod (9, 90) in such a way to prevent the actuation of the catch (5) by acting on the opening lever (3).

4. Door handle as defined in claim 3, characterised in that the blocking rod (9, 90) has an upper hooking pin (9c, 90c) with vertical axis that, at the end of the actuation travel of the rod (9, 90), engages into a notch (3d, 30d) suitably provided along the external profile of the opening lever (3, 30) that is positioned partially above the blocking lever (9, 90) subject to the ejection thrust of a spring (10) housed inside a cavity (8a) on the track (8).

5. Door handle as defined in claim 1, characterised in that the hook (3c) of the opening lever (3) is designed to penetrate the through hole (5a) provided on the body of the said spring latch (5).

6. Door handle as defined in claim 1, characterised in that the ending hook (3c, 30c) of the opening lever (3, 30) engages with a vertical lever (51) in its central section, the head (51a) of said vertical lever (51) being engaged with a hooked appendix (50a) provided on the rear side of the spring latch (50) which is housed in a housing (40a) of said housing and guiding box (40); wherein a base of said vertical lever (51) is pivoted by means of a horizontal pin (51b) inside a fork (40) on the rear side of the plate (52) that supports the box (40) and is tightened onto the leaf (B) of the door.

7. Door handle as defined in claim 6, characterised in that the opening lever (30) mounted on the internal handle (MI) ends with a forked appendix (30b) with a first hook (30c) and a second hook (30e); the first hook (30c) in idle state being adjacent and overlapped with respect the hook (3c) of the opening lever (3) mounted on the external handle (ME).

8. Door handle as defined in claim 7, characterised in that the opening lever (90) mounted on the internal handle (MI) ends with a catch (90b) capable of interfering, when the rod (90) is actuated, with the internal profile of the hook (3c) of the opening lever (3) mounted on the external handle (ME), thus preventing the door from being opened from outside.

9. Door handle as defined in claim 7, characterised in that, when the rod (90) is inserted, the second hook (30d) is engaged on the back of the lever (51), thus being interfered when the lever (51) oscillates backwards due to a backward travel of the latch (50) not caused by the actuation of the opening lever (30).

10. Door handle as defined in claim 1, characterised in that it comprises a lock with cylindrical block (12) with key (11), housed at the end of the rectilinear section (TI) of the external handle (ME); it being provided that the shaft (12a) of the cylinder (12) is fixed to an L-shaped bracket (13), whose horizontal wing (13a) is dimensioned in such a way that when it is positioned on a vertical plane, the opening lever (3, 30) cannot be actuated since the insertion of the button (3a) inside the handle-body (1) is opposed by the wing (13a) that, conversely, cannot obstruct the travel of the opening button (3a) when the wing (13a) is in horizontal parallel position with respect the button (3a).

11. Door handle as defined in claim 10, characterised in that it comprises a lock with bolt (121) with key (110) housed at the end of the rectilinear section (TI) of the external handle (ME); it being provided that, once it has reached the maximum forward position, the bolt (121) can be positioned immediately behind the opening button (3a), thus opposing the actuation of the opening lever (3, 30).

12. Door handle as defined in claim 11, characterised in that the bolt (121) is housed in a cylindrical chamber (120), in which the key (110) is inserted from the back opening, while the bolt (121) projects from the front opening, which is actuated by the key (110) by means of a rotary intermediate drum (122) housed inside the chamber (120), since the key (110) is provided with a front pair of pins (110a) suitable to be inserted into a corresponding pair of holes (122a) on the rear ending section (122b) of the drum (122), which is frontally provided with a central pin (122) inserted into a suitable housing (121a) on the rear ending section (121b) of the bolt (121); it being provided that the pin (122c) and the housing (121a) are coupled in such a way that the pin (122c) can slide in axial direction inside the housing (121a), but cannot turn, so that each rotary movement of the drum (122) is transmitted to the bolt (121), which can move forward or backward in axial direction with respect the drum, without losing prismatic coupling thanks to the pin (122c).

13. Door handle as defined in claim 12, characterised in that the key (110) is provided with a reference radial dowel (110c) that projects from the lateral surface and is inserted and slides inside a suitable groove (120c) on the internal surface of the rear opening (120a) of the chamber (120); it being provided that the groove (120c) has an L-shaped profile formed of a first longitudinal section and a second transversal section that extends for a semicircle.

14. Door handle as defined in claim 12, characterised in that both the rotary drum (122) and the bolt (121) have guiding grooves (122d) and (121d) on the lateral surface, where radial pins (122e and 121e) applied on the chamber (120) engage; where the guiding groove (122d) of the rotary drum (122) has a circular development on an orthogonal plane to the rotation axis of the drum, and the guiding groove (121d) of the bolt (121) has a circular development formed of a first section (121d′) identical and parallel to the groove (122d) and a second section (122d″) with helical development.

15. Door handle as defined in claim 11, characterised in that the key (11) and the key (110) are housed inside a shaped piece (111) that protects and hides the real key, with the piece being shaped in such a way that it matches the aesthetics of the body-handle (1).
